(19) United States
(12) Patent Application Publication
(10) Pub. No.: US 2024/0348736 A1
(43) Pub. Date: Oct. 17, 2024

(54) IMAGE PROCESSING APPARATUS, CONTROL METHOD, AND NON-TRANSITORY COMPUTER-EXECUTABLE MEDIUM

(71) Applicant: PFU LIMITED, Kahoku-shi (JP)

(72) Inventors: Yuta Hashimoto, Kahoku-shi (JP); Hirokazu Kawatani, Kahoku-shi (JP); Yasuhito Nagakoshi, Kahoku-shi (JP)

(21) Appl. No.: 18/625,901

(22) Filed: Apr. 3, 2024

(30) Foreign Application Priority Data
Apr. 17, 2023 (JP) 2023-067261

(51) Int. Cl. H04N 1/00

(52) U.S. Cl. CPC H04N 1/0097; H04N 1/00946

(57) ABSTRACT

An image processing apparatus includes circuitry. The circuitry acquires setting information relating to conveyance processing, image-capturing processing, or image processing of an image reading apparatus and a storage destination of a file that is generated in accordance with the setting information. The setting information and the storage destination are set by a user. The circuitry identifies characteristic information of an existing file present in the storage destination. The circuitry determines whether the setting information corresponds to the characteristic information and generates a determination result. The circuitry notifies the user of information relating to the determination result in a case where the determination result indicates that the setting information does not correspond to the characteristic information.

### CROSS-REFERENCE TO RELATED APPLICATION

This patent application is based on and claims priority pursuant to 35 U.S.C. § 119 (a) to Japanese Patent Application No. 2023-067261, filed on Apr. 17, 2023, in the Japan Patent Office, the entire disclosure of which is hereby incorporated by reference herein.

### BACKGROUND

### Technical Field

Embodiments of the present disclosure relate to an image processing apparatus, a control method, and a non-transitory computer-executable medium.

### Related Art

In recent years, image reading apparatuses such as scanners that capture images of media to generate images are used for various purposes of use to capture images of media of various types. The quality of an image required for the image reading apparatus varies depending on the purpose of use of the image reading apparatus or the type of medium to be read. In general, the image reading apparatus can set various setting information relating to conveyance processing, image-capturing processing, or image processing on a medium, such as medium separation, resolution, color, or correction, to generate an appropriate image corresponding to, for example, the purpose of use or the type of medium. The image reading apparatus can also set a storage destination of each image file generated in accordance with each setting information so that a user can easily use the image file. However, when the storage destination of the image file generated in accordance with each setting is not appropriate, the user has to perform an operation such as moving the image file to an appropriate storage destination.

An image reading apparatus has been known that receives a reading instruction to designate a storage destination folder of read data, acquires reading setting information from the storage destination folder, and reads a document under a reading condition set based on the acquired reading setting information.

### SUMMARY

According to an embodiment of the present disclosure, an image processing apparatus includes circuitry. The circuitry acquires setting information relating to conveyance processing, image-capturing processing, or image processing of an image reading apparatus and a storage destination of a file that is generated in accordance with the setting information. The setting information and the storage destination are set by a user. The circuitry identifies characteristic information of an existing file present in the storage destination. The circuitry determines whether the setting information corresponds to the characteristic information and generates a determination result. The circuitry notifies the user of information relating to the determination result in a case where the determination result indicates that the setting information does not correspond to the characteristic information.

According to an embodiment of the present disclosure, a control method includes acquiring setting information relating to conveyance processing, image-capturing processing, or image processing of an image reading apparatus and a storage destination of a file that is generated in accordance with the setting information. The setting information and the storage destination are set by a user. The control method includes identifying characteristic information of an existing file present in the storage destination. The control method includes determining whether the setting information corresponds to the characteristic information and generating a determination result. The control method includes notifying the user of information relating to the determination result in a case where the determination result indicates that the setting information does not correspond to the characteristic information.

According to an embodiment of the present disclosure, a non-transitory computer-executable medium stories a control program storing a plurality of instructions, which, when executed by one or more processors, causes the one or more processors to perform a method. The method includes acquiring setting information relating to conveyance processing, image-capturing processing, or image processing of an image reading apparatus, and a storage destination of a file that is generated in accordance with the setting information. The setting information and the storage destination are set by a user. The method includes identifying characteristic information of an existing file present in the storage destination. The method includes determining whether the setting information corresponds to the characteristic information and generating a determination result. The method includes notifying the user of information relating to the determination result in a case where the determination result indicates that the setting information does not correspond to the characteristic information.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram schematically illustrating a configuration of an image processing system, according to an embodiment of the present disclosure;

FIG. 2 is a diagram illustrating an example of a data structure of a setting information table, according to an embodiment of the present disclosure;

FIG. 3 is a diagram illustrating an example of a data structure of a type table, according to an embodiment of the present disclosure;

FIG. 4A is a diagram schematically illustrating configurations of a first storage device and a first processing circuit, according to an embodiment of the present disclosure;

FIG. 4B is a diagram schematically illustrating configurations of a second storage device and a second processing circuit, according to an embodiment of the present disclosure;

FIG. 5 is a flowchart of an example of an operation of a determination process, according to an embodiment of the present disclosure;

FIG. 6 is a flowchart of an example of an operation of an identification process, according to an embodiment of the present disclosure; and

FIG. 7 is a block diagram schematically illustrating a configuration of another second processing circuit, according to another embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a”, “an”, and “the” are intended to include the plural forms as well, unless the context clearly indicates otherwise.

An image processing apparatus, a control method, and a control program according to embodiments of the present disclosure are described below with reference to the drawings. However, it is to be understood that the technical scope of the present disclosure is not limited to the embodiments of the disclosure, and pertains to the disclosure described in the claims and the equivalents of the disclosure.

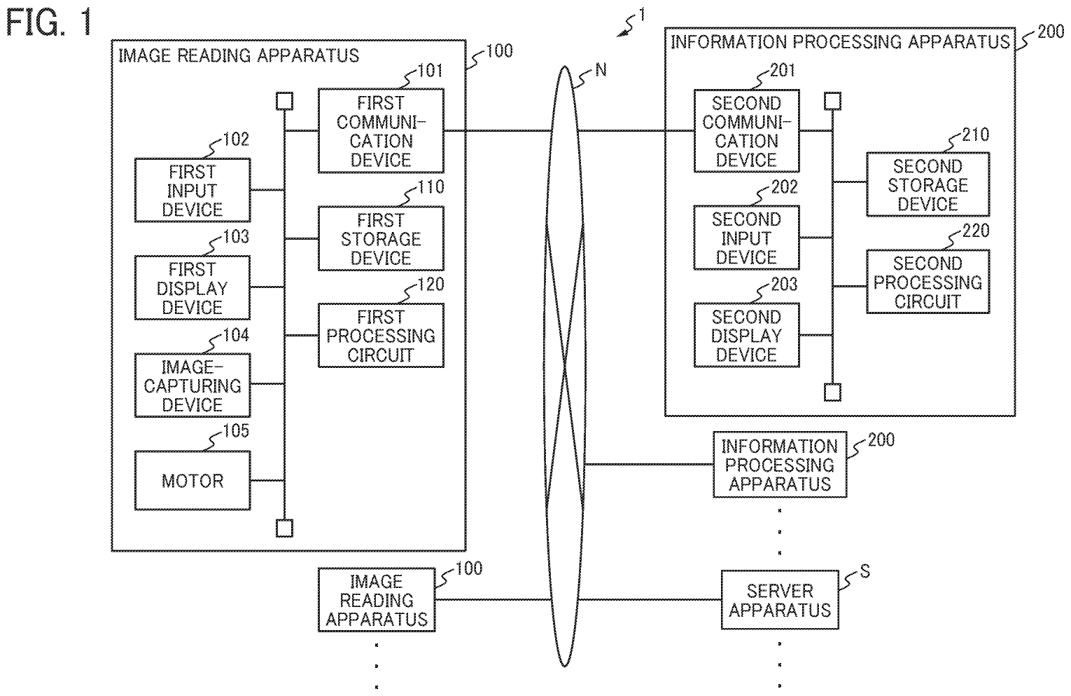

FIG. 1 is a diagram schematically illustrating a configuration of an image processing system 1 according to an embodiment.

As illustrated in FIG. 1, the image processing system 1 includes one or more image reading apparatuses 100, one or more information processing apparatuses 200, and one or more server apparatuses S. The image reading apparatus 100 and the information processing apparatus 200 are examples of an image processing apparatus. The image reading apparatus 100, the information processing apparatus 200, and the server apparatus S are communicably connected to one another via a network N. The network Nis, for example, the Internet or an intranet.

The image reading apparatus 100 is, for example, a scanner apparatus. The scanner apparatus includes an auto document feeder (ADF) scanner apparatus that captures an image of a medium that is a document while conveying the medium, or a flatbed scanner apparatus that captures an image of a medium in a fixed manner. Examples of the medium include a sheet of plain paper, a sheet of thin paper, a sheet of thick paper, and a card. Examples of the medium further include various types of media such as a receipt, a business card, a bill, and an invoice. The image reading apparatus 100 may be, for example, a facsimile, a copier, or a multifunction peripheral (MFP). The image reading apparatus 100 may be, for example, a mobile phone, a smartphone, a tablet computer, or a laptop personal computer that captures an image of, for example, a person, an object, or a landscape.

The information processing apparatus 200 is, for example, a personal computer, a laptop personal computer, a tablet computer, or a smartphone. The information processing apparatus 200 may be a server provided in a cloud network. The server apparatus S is, for example, a server provided in a cloud network.

The image reading apparatus 100 includes a first communication device 101, a first input device 102, a first display device 103, an image-capturing device 104, a motor 105, a first storage device 110, and a first processing circuit 120.

The first communication device 101 includes an antenna that transmits and receives wireless signals, and a wireless communication interface circuit to transmit and receive signals through a wireless communication line according to a predetermined communication protocol such as a wireless local area network (LAN). The first communication device 101 transmits and receives image data and various types of information to and from the information processing apparatus 200 in response to an instruction from the first processing circuit 120. The first communication device 101 may include a wired communication interface circuit to transmit and receive signals through a wired communication line according to a predetermined communication protocol such as a wired LAN.

The first input device 102 includes an input device such as a button and an interface circuit that acquires a signal from the input device. The first input device 102 receives an operation by a user, and outputs a signal corresponding to the operation by the user to the first processing circuit 120.

The first display device 103 includes a display including, for example, liquid crystal or organic electro-luminescence (EL), and an interface circuit that outputs image data to the display. The first display device 103 displays various types of information on the display in response to an instruction from the first processing circuit 120.

The image-capturing device 104 captures an image of a medium and generates an input image. The image-capturing device 104 includes an imaging sensor employing a reduction optical system including an imaging element including a one-dimensional or two-dimensional charge coupled device (CCD). The image-capturing device 104 further includes a light source that emits light, a lens that forms an image on the imaging element, and an analog-to-digital (A/D) converter that amplifies an electric signal output from the imaging element and converts the amplified electric signal into a digital signal. In the image-capturing device 104, the imaging sensor captures an image of the front side and/or the back side of a medium, generates an analog image signal, and outputs the generated analog image signal, and the A/D converter converts the analog image signal to a digital input image and outputs the digital input image to the first processing circuit 120. Instead of the CCD, an imaging sensor employing a reduction optical system including an imaging element including a complementary metal oxide semiconductor (CMOS) may be used. A line sensor employing a unity magnification optical system including imaging elements including CMOSs or CCDs may be used.

The motor 105 rotates a roller to convey a medium in accordance with a control signal from the first processing circuit 120. Alternatively, the motor 105 moves the image-capturing device 104 in a sub-scanning direction in accordance with a control signal from the first processing circuit 120.

The first storage device 110 includes memories such as a random access memory (RAM) and a read only memory (ROM), a fixed disk device such as a hard disk, or a portable memory such as a flexible disk or an optical disk. The first storage device 110 stores computer programs, databases, tables, and so forth, which are used for various processes of the image reading apparatus 100. The computer programs may be installed in the first storage device 110 from a computer-readable portable recording medium using, for example, a known setup program. The portable recording medium is, for example, a compact disk read only memory (CD-ROM) or a digital versatile disk read only memory (DVD-ROM). The computer programs may be distributed from, for example, a server and installed in the first storage device 110.

The first processing circuit 120 operates according to a program stored in the first storage device 110 in advance. The first processing circuit 120 is, for example, a central processing unit (CPU). As the first processing circuit 120, for example, a digital signal processor (DSP), a large scale integration (LSI), an application specific integrated circuit (ASIC), or a field-programming gate array (FPGA) may be used.

The first processing circuit 120 is connected to the first communication device 101, the first input device 102, the first display device 103, the image-capturing device 104, the motor 105, the first storage device 110, and so forth, and controls these components. The first processing circuit 120 performs control of transmitting and receiving data to and from the information processing apparatus 200 via the first communication device 101, input control of the first input device 102, display control of the first display device 103, imaging control of the image-capturing device 104, drive control of the motor 105, and so forth.

The information processing apparatus 200 includes a second communication device 201, a second input device 202, a second display device 203, a second storage device 210, and a second processing circuit 220.

The second communication device 201 includes an antenna that transmits and receives wireless signals, and a wireless communication interface circuit to transmit and receive signals through a wireless communication line according to a predetermined communication protocol such as a wireless LAN. The second communication device 201 transmits and receives image data and various types of information to and from the image reading apparatus 100 in response to an instruction from the second processing circuit 220. The second communication device 201 may include a wired communication interface circuit to transmit and receive signals through a wired communication line according to a predetermined communication protocol such as a wired LAN.

The second input device 202 includes an input device, such as a keyboard or a mouse, and an interface circuit that acquires a signal from the input device. The second input device 202 outputs a signal corresponding to an operation by the user to the second processing circuit 220.

The second display device 203 includes a display including, for example, liquid crystal or organic EL, and an interface circuit that outputs image data to the display. The second display device 203 displays various types of information on the display in response to an instruction from the second processing circuit 220.

The second storage device 210 includes memories such as a RAM and a ROM, a fixed disk device such as a hard disk, or a portable memory such as a flexible disk or an optical disk. The second storage device 210 stores computer programs, databases, tables, and so forth, which are used for various processes of the information processing apparatus 200. The computer programs may be installed in the second storage device 210 from a computer-readable portable recording medium, such as a CD-ROM or a DVD-ROM, using, for example, a known setup program. The computer programs may be distributed from, for example, a server and installed in the second storage device 210.

The second storage device 210 stores, as data, a setting information table, a type table, and so forth in advance. The details of the setting information table and the type table will be described later.

The second processing circuit 220 operates according to a program stored in the second storage device 210 in advance. The second processing circuit 220 is, for example, a CPU. As the second processing circuit 220, for example, a DSP, a LSI, an ASIC, or a FPGA may be used.

The second processing circuit 220 is connected to the second communication device 201, the second input device 202, the second display device 203, the second storage device 210, and so forth, and controls these components. The second processing circuit 220 performs control of transmitting and receiving data to and from the image reading apparatus 100 via the second communication device 201, input control of the second input device 202, display control of the second display device 203, and so forth. The second processing circuit 220 analyzes setting information and a storage destination set by the user, and determines whether the setting information corresponds to the storage destination. The second processing circuit 220 notifies the user of a warning when the setting information does not correspond to the storage destination, and sets the setting information and the storage destination in the image reading apparatus 100 via the second communication device 201 when the setting information corresponds to the storage destination.

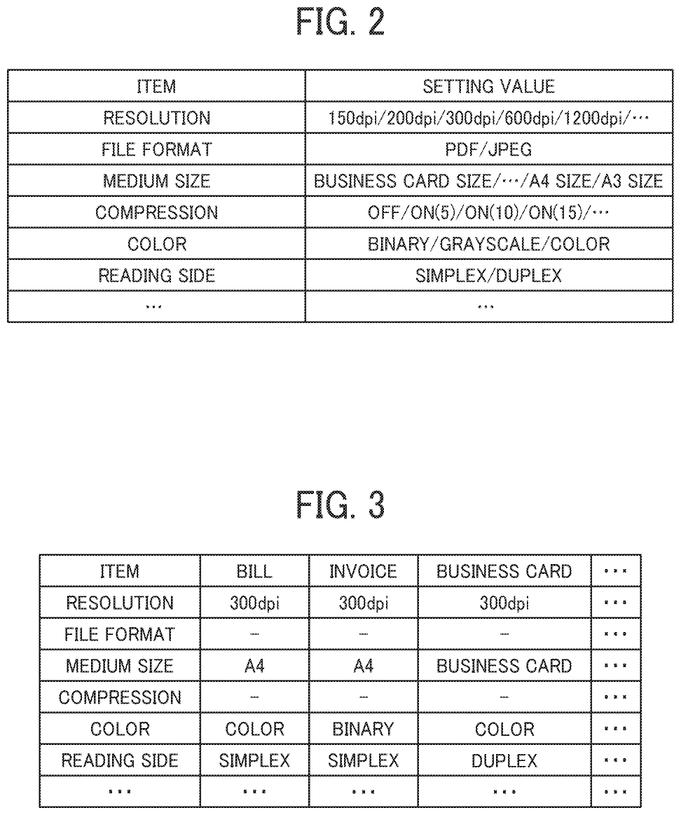

FIG. 2 is a table presenting an example of a data structure of a setting information table.

The setting information table stores a setting value that can be set for each item of one or more items that are determined in setting information. The setting information is information relating to conveyance processing, image-capturing processing, or image processing of the image reading apparatus 100. The setting information is information for determining, for example, a condition when an image of a medium is captured or an image processing to be executed on the captured image by the image reading apparatus 100. The items determined in the setting information include resolution, file format, medium size, compression, color, reading side, multi-image output, spread combination, optical character recognition (OCR), barcode recognition, electronic document (e-document) reading setting, size detection, sharpness correction, orientation correction, dropout color, background pattern removal, moire reduction, tone curve adjustment, tab cropping, ruled line removal, color reduction process, medium separation, multi-feed detection, and so forth.

The resolution, medium size, color, reading side, and so forth are settings relating to the image-capturing processing. The file format, compression, multi-image output, spread combination, OCR, barcode recognition, e-document reading setting, size detection, sharpness correction, orientation correction, dropout color, background pattern removal, moire reduction, tone curve adjustment, tab cropping, ruled line removal, color reduction process, and so forth are settings relating to the image processing. The medium separation, multi-feed detection, and so forth are settings relating to the conveyance processing.

The resolution is a setting of the resolution of an image to be generated. As a setting value of the resolution, for example, 150 dots per inch (dpi), 200 dpi, 300 dpi, 600 dpi, or 1200 dpi is set. The file format is a setting of the format of a file of an image to be generated. As a setting value of the file format, for example, portable document format (PDF) or Joint Photographic Experts Group (JPEG) is set. The medium size is a setting of the size of a medium included in an image to be generated. As a setting value of the medium size, for example, business card size, A4 size, or A3 size is set. The compression is a setting for executing image compression such as JPEG on an image to be generated. As a setting value of the compression, for example, ON (when ON is set, additionally, a quantization value) or OFF is set. The color is a setting of the color of an image to be generated. As a setting value of the color, for example binary, grayscale, or color is set.

The reading side is a setting of a side from which an image of a medium is captured. As a setting value of the reading side, for example, simplex or duplex is set. The multi-image output is a setting for generating a plurality of images having hues different from each other on one medium. As a setting value of the multi-image output, for example, ON or OFF is set. The spread combination is a setting for arranging two images obtained by separately capturing images of continuous pages and combining the two images into one image to generate a spread image. As a setting value of the spread combination, for example, ON or OFF is set. The OCR is a setting for performing character recognition on a generated image. As a setting value of the OCR, for example, ON (when ON is set, additionally, a language) or OFF is set. The barcode recognition is a setting for performing barcode recognition on a generated image. As a setting value of the barcode recognition, for example ON or OFF is set. The e-document reading setting is a setting determined for reading and storing an e-document. As a setting value of the e-document reading setting, for example, ON or OFF is set.

The size detection is a setting for cropping a medium area from an image. As a setting value of the size detection, for example, automatic size detection in which the medium area is cropped by detecting an end position of the medium within the image or fixed size in which the medium area is cropped with a fixed size is set. The sharpness correction is a setting for sharpening an image using a known image processing technique such as an unsharp masking process. As a setting value of the sharpness correction, for example, ON or OFF is set. The orientation correction is a setting for correcting the orientation of a medium included in an image using a known image processing technique such as a rotation process. As a setting value of the orientation correction, for example, ON or OFF is set.

The dropout color is a setting for removing a specific color component included in an image using a known image processing technique. As a setting value of the dropout color, for example, ON or OFF is set, and when ON is set, a color component to be removed is additionally set. The dropout color is used to generate an image in which an object having a specific color component, such as a stamp, is removed from an image of a medium with the object. The background pattern removal is a setting for removing a background pattern (continuous pattern of, for example, dots or thin lines) included in the background using a known image processing technique. As a setting value of the background pattern removal, for example, ON or OFF is set. The moire reduction is a setting for reducing moire in an image using a known image processing technique. As a setting value of the moire reduction, for example, ON or OFF is set.

The tone curve adjustment is a setting for adjusting brightness or contrast of an image. As a setting value of the tone curve adjustment, for example, ON or OFF is set. The tab cropping is a setting for removing a tab, such as a sticky note or a sticky label protruding from a rectangle, from an image. As a setting value of the tab cropping, for example, ON or OFF is set. The ruled line removal is a setting for removing ruled lines in a medium from an image using a known image processing technique. As a setting value of the ruled line removal, for example, ON or OFF is set. The color reduction process is a setting for limiting (reducing) the value range of respective red, green, and blue (RGB) color components. As a setting value of the color reduction process, for example, ON or OFF is set, and when ON is set, the value range of respective colors are additionally set.

The medium separation is a setting of whether to convey media while separating the media one by one or to convey the media without separating the media when the media are conveyed. As a setting value of the medium separation, for example, ON (separation) or OFF (non-separation) is set. When a plurality of media is collectively conveyed, the medium separation is set to ON. When a booklet such as a passport is conveyed, the medium separation is set to OFF. The multi-feed detection is a setting of whether to notify a user of a warning or stop conveyance when multi-feed of media occurs. As a setting value of the multi-feed detection, for example, ON or OFF is set. When a plurality of sheets is conveyed, the multi-feed detection is set to ON. When, for example, an envelope or a sheet with a sticky note is conveyed, the multi-feed detection is set to OFF.

FIG. 3 is a table presenting an example of a data structure of a type table.

The type table stores setting information (a combination of setting values of items) for each of one or more medium types which the image reading apparatus 100 can read, and when capturing one of medium types, the setting information corresponding to the medium type is set. The medium types include bill, invoice, business card, receipt, and so forth. A setting value is not set for an item without a representative setting value that is set when an image of a medium relating to each medium type is captured.

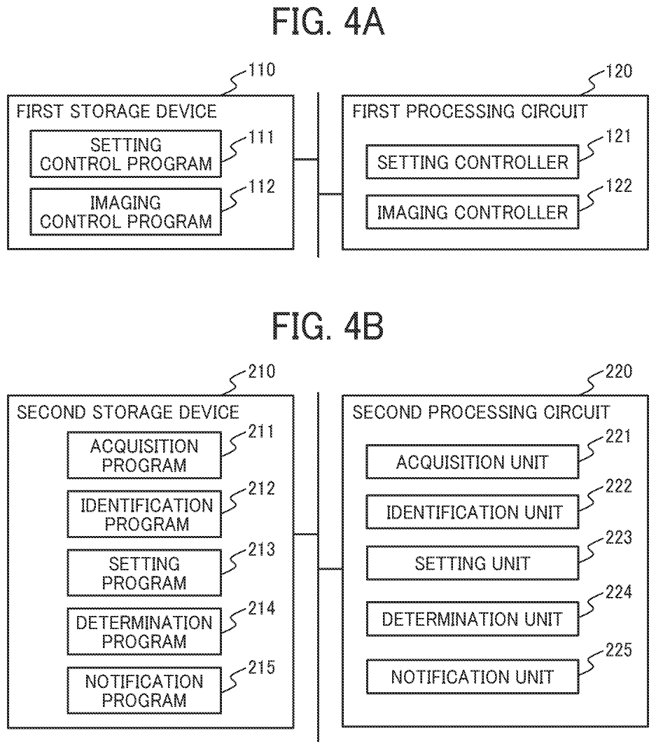

FIG. 4A is a diagram schematically illustrating configurations of the first storage device 110 and the first processing circuit 120.

As illustrated in FIG. 4A, the first storage device 110 stores programs, such as a setting control program 111 and an imaging control program 112. These programs are functional modules implemented by software operating on the processor. The first processing circuit 120 reads the programs from the first storage device 110 and operates according to the read programs. Accordingly, the first processing circuit 120 functions as a setting controller 121 and an imaging controller 122.

FIG. 4B is a diagram schematically illustrating configurations of the second storage device 210 and the second processing circuit 220.

As illustrated in FIG. 4B, the second storage device 210 stores programs, such as an acquisition program 211, an identification program 212, a setting program 213, a determination program 214, and a notification program 215. These programs are functional modules implemented by software operating on the processor. The second processing circuit 220 reads the programs from the second storage device 210 and operates according to the read programs. Accordingly, the second processing circuit 220 functions as an acquisition unit 221, an identification unit 222, a setting unit 223, a determination unit 224, and a notification unit 225.

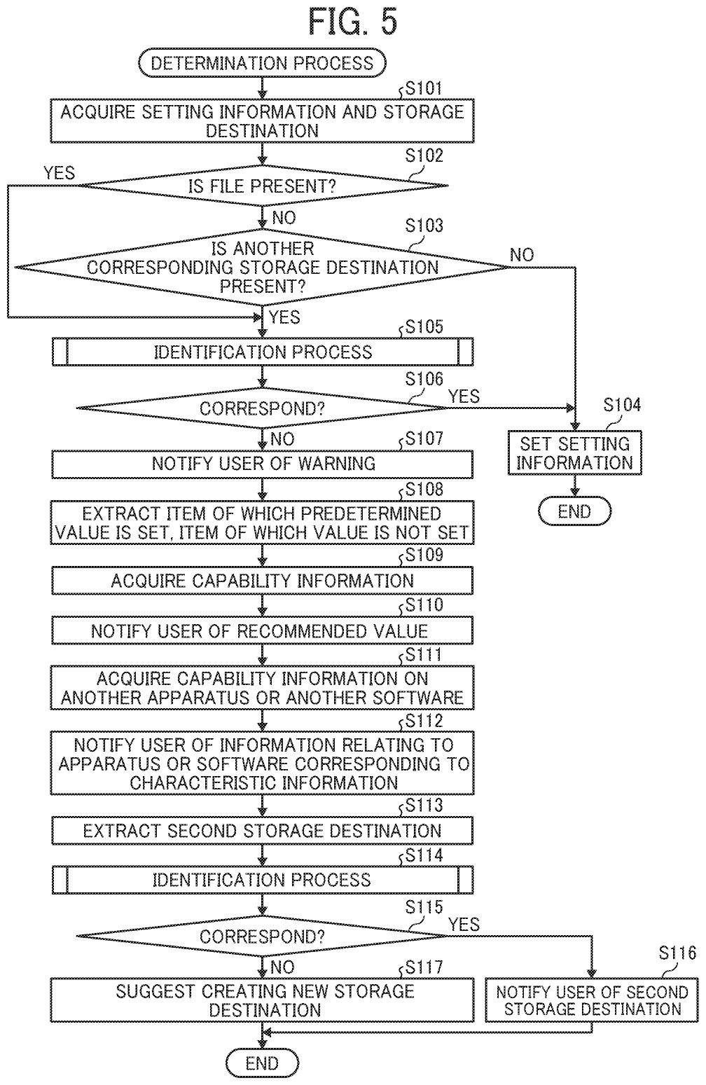

FIG. 5 is a flowchart presenting an example of an operation of a determination process by the information processing apparatus 200. The operation of the determination process is described below with reference to the flowchart presented in FIG. 5. The flow of the operation described below is executed mainly by the second processing circuit 220 in cooperation with each component of the information processing apparatus 200 based on a program stored in the second storage device 210 in advance. The determination process is executed at a desirable timing, for example, when the user sets setting information in the image reading apparatus 100 and/or a storage destination of a file to be generated in accordance with the setting information, when a warning notification function is set to be enabled, or when image capturing of a medium is instructed.

The acquisition unit 221 acquires setting information in the image reading apparatus 100 and a storage destination of a file that is generated in accordance with the setting information. The setting information and the storage destination are set by the user (step S101).

The setting controller 121 of the image reading apparatus 100 acquires the setting information and the storage destination input by the user using the first input device 102, and transmits the setting information and the storage destination to the information processing apparatus 200 via the first communication device 101. The acquisition unit 221 receives the setting information and the storage destination from the image reading apparatus 100 via the second communication device 201 to acquire the setting information and the storage destination. Alternatively, the acquisition unit 221 acquires the setting information and the storage destination input by the user using the second input device 202 of the information processing apparatus 200. The acquisition unit 221 may receive setting information set by the user in a second image reading apparatus different from the image reading apparatus 100 to be set, from the second image reading apparatus via the second communication device 201 to acquire the setting information in the second image reading apparatus. The setting controller 121 of the second image reading apparatus reads the setting information already stored (set) in the first storage device 110 from the first storage device 110, and transmits the setting information to the information processing apparatus 200 via the first communication device 101.

The file is an image file such as a JPEG file or PDF file including an image generated by the image reading apparatus 100 in accordance with the setting information. The storage destination is, for example, a specific address such as a folder or a uniform resource locator (URL) in the second storage device 210 of the information processing apparatus 200. The storage destination may be an address in a storage device of an information processing apparatus 200 different from the information processing apparatus 200 that has acquired the storage destination, the image reading apparatus 100, or the server apparatus S.

The identification unit 222 determines whether an existing file generated by the image reading apparatus 100 in the past is present in the storage destination set by the user (step S102). When the storage destination is a storage device of an apparatus different from the information processing apparatus 200, the identification unit 222 receives information relating to the storage destination being set, another storage destination located in the vicinity of the storage destination being set, and an existing file present in each of the storage destinations, from the apparatus of the storage destination via the second communication device 201. When an existing file is present in the storage destination being set, the identification unit 222 does not particularly execute a process, and proceeds to step S105. When the storage destination being set is not accessible for any reason, the identification unit 222 notifies the user of a warning indicating that the storage destination being set is not accessible, and ends the series of steps.

By contrast, when an existing file is not present in the storage destination being set, the identification unit 222 determines whether another storage destination corresponding to the storage destination being set is present (step S103). The identification unit 222 extracts a storage destination having a name based on the same rule as the rule of the storage destination being set among storage destinations present in the same hierarchy as the hierarchy of the storage destination being set. The rule is, for example, a combination of a numerical value and a character (word), such as “year”, “month”, or “day”. For example, when the name of the storage destination being set is “year 2023”, the identification unit 222 extracts a storage destination having a name such as “year 2021” or “year 2022” present in the same hierarchy. When the extracted storage destination includes a storage destination in which an existing file is present, the identification unit 222 identifies the storage destination as the other storage destination corresponding to the storage destination being set. When a plurality of storage destinations is identified as the other storage destination corresponding to the storage destination being set, the identification unit 222 identifies, for example, a storage destination having the latest creation date and time as the other storage destination corresponding to the storage destination being set.

When another storage destination corresponding to the storage destination being set is not present, the setting unit 223 sets the setting information and the storage destination set by the user in the corresponding image reading apparatus 100 (step S104), and ends the series of steps. The setting unit 223 transmits a setting request signal that designates the setting information and the storage destination to the corresponding image reading apparatus 100 via the second communication device 201. When the setting controller 121 of the image reading apparatus 100 receives the setting request signal from the information processing apparatus 200 via the first communication device 101, the setting controller 121 associates the setting information and the storage destination designated in the received setting request signal with each other and stores the setting information and the storage destination in the first storage device 110.

Thereafter, when the imaging controller 122 receives an instruction signal that designates setting information and instructs image capturing of a medium from the first input device 102 or from the information processing apparatus 200 via the first communication device 101, the imaging controller 122 executes the conveyance processing, the image-capturing processing, and the image processing in accordance with the setting information designated in the instruction signal. The imaging controller 122 controls the image-capturing device 104 and the motor 105 in accordance with the designated setting information to acquire an input image, executes the image processing on the input image in accordance with the designated setting information, and generates a file. The imaging controller 122 transmits a request signal including the generated file and a storage destination stored in association with the setting information of the file and requesting that the file is to be stored in the storage destination to an apparatus corresponding to the storage destination via the first communication device 101. The apparatus that has received the request signal stores the file included in the request signal in the storage destination included in the request signal. When the storage destination is the first storage device 110 of the image reading apparatus 100, the imaging controller 122 stores the generated file in the storage destination of the first storage device 110.

By contrast, when an existing file is present in the storage destination being set, or when the other storage destination corresponding to the storage destination being set is present, the identification unit 222 executes an identification process (step S105). In the identification process, the identification unit 222 identifies characteristic information of the existing file based on the existing file present in the corresponding storage destination (the storage destination set by the user or the other storage destination corresponding to the storage destination). The identification unit 222 identifies existing file setting information relating to the conveyance processing, the image-capturing processing, or the image processing used when the existing file is generated as the characteristic information. Items determined in the existing file setting information are the same as the items determined in the setting information. Alternatively, the identification unit 222 identifies a medium type corresponding to the existing file as the characteristic information. The details of the identification process will be described later.

The determination unit 224 determines whether the setting information set by the user corresponds to the characteristic information identified in the identification process (step S106).

When the characteristic information is the existing file setting information, the determination unit 224 determines whether the setting value in the setting information matches the setting value in the existing file setting information for each item with the setting value identified in the identification process among the items determined in the existing file setting information. The determination unit 224 calculates the ratio of the number of items of which the setting values in the setting information match the setting values in the existing file setting information to the number of items of which the setting values are identified in the identification process as a matching degree between the setting information and the characteristic information. The determination unit 224 may calculate the number of items of which the setting values in the setting information match the setting values in the existing file setting information as the matching degree between the setting information and the characteristic information. In the setting information, an item of which a predetermined value is set and/or an item of which a value is not set may be excluded from targets for calculating the matching degree. The determination unit 224 determines that the setting information corresponds to the characteristic information when the calculated matching degree is a predetermined threshold value or more, and determines that the setting information does not correspond to the characteristic information when the calculated matching degree is less than the predetermined threshold value.

When the characteristic information is a medium type corresponding to the existing file, the determination unit 224 identifies a medium type corresponding to the setting information set by the user. The information processing apparatus 200 stores in advance a combination of setting values of items of setting information corresponding to each medium type in the second storage device 210 for each of a plurality of medium types. The determination unit 224 identifies a medium type having the largest number of items of which the setting values match the setting values of the setting information being set among the plurality of medium types, as the medium type corresponding to the setting information being set. The medium type corresponding to the setting information may be set by the user together with the setting information and may be acquired by the acquisition unit 221. The determination unit 224 determines that the setting information corresponds to the characteristic information when the identified medium type is the same as the medium type corresponding to the existing file, and determines that the setting information does not correspond to the characteristic information when the identified medium type is not the same as the medium type corresponding to the existing file.

The determination unit 224 may determine whether the setting information corresponds to the characteristic information based on an item different for each medium type. In this case, the information processing apparatus 200 stores an item of setting information strongly indicating a characteristic of each medium type in the second storage device 210 in advance for each of the plurality of medium types. For example, items that strongly indicate characteristics of business card include the medium size and the OCR, and items that strongly indicate characteristics of bill include the medium size and the color. The determination unit 224 determines whether the setting value in the setting information matches the setting value in the existing file setting information for each item strongly indicating the characteristic of the medium type corresponding to the setting information, and calculates a matching degree between the setting information and the characteristic information. The determination unit 224 determines whether the setting information corresponds to the characteristic information based on whether the calculated matching degree is a predetermined threshold value or more.

When it is determined that the setting information corresponds to the characteristic information, the setting unit 223 sets the setting information and storage destination being set in the corresponding image reading apparatus 100 (step S104), and ends the series of steps.

By contrast, when it is determined that the setting information does not correspond to the characteristic information, the notification unit 225 notifies the user of a warning indicating that the setting information set by the user does not correspond to the storage destination set by the user (step S107). The warning is an example of information relating to a determination result. The notification unit 225 displays the warning on the second display device 203, or transmits the warning to the image reading apparatus 100 or another information processing apparatus 200 via the second communication device 201 so that the warning is displayed on the apparatus to notify the user of the warning.

In a case where the characteristic information is the existing file setting information, and it is determined that the setting information does not correspond to the existing file setting information, the notification unit 225 notifies the user that the setting information is not appropriate as a warning. When an individual item in the setting information does not correspond to the existing file setting information, the individual item of the setting information set by the user is likely erroneous. In this case, the information processing apparatus 200 notifies the user of that the individual item is not appropriate, thereby avoiding a setting error of the setting information. In this case, the notification unit 225 may notify the user that the storage destination is not appropriate or at least one of the setting information and the storage destination is not appropriate as a warning.

By contrast, in a case where the characteristic information is the medium type corresponding to the existing file, when it is determined that the setting information does not correspond to the medium type corresponding to the existing file, the notification unit 225 notifies the user that the storage destination is not appropriate as a warning. When the medium type corresponding to the setting information does not correspond to the medium type corresponding to the existing file, the entire settings do not correspond to each other, and the setting of the storage destination is likely erroneous. In this case, the information processing apparatus 200 notifies the user of that the storage destination is not appropriate, thereby avoiding a setting error of the storage destination. In this case, the notification unit 225 may notify the user that the setting information is not appropriate or at least one of the setting information and the storage destination is not appropriate as a warning.

The notification unit 225 extracts an item of which a predetermined value is set and/or an item of which a value is not set in the setting information set by the user (step S108).

The acquisition unit 221 acquires capability information indicating a capability relating to the conveyance processing, the image-capturing processing, or the image processing of the image reading apparatus 100 (step S109). Items determined in the capability information are the same as the items determined in the setting information. The capability information indicates a list of setting values executable by the image reading apparatus 100, that is, setting values settable in the image reading apparatus 100 for the determined items.

The notification unit 225 determines a recommended value of a setting relating to the conveyance processing, the image-capturing processing, or the image processing, and notifies the user of the recommended value in a manner similar to the process in step S107 (step S110). The recommended value of the setting relating to the image-capturing processing or the image processing is an example of information relating to a determination result.

The notification unit 225 determines the recommended value based on the characteristic information identified in the identification process. For example, the notification unit 225 determines the setting value of each item of the existing file setting information identified in the identification process as the recommended value. Accordingly, the user can recognize the setting information corresponding to the existing file present in the storage destination being set and can appropriately correct the setting information being set. Thus, the information processing apparatus 200 can enhance convenience of the user.

The notification unit 225 determines the recommended value at least for the item of which a predetermined value is set and/or the item of which a value is not set in the setting information extracted in step S108. Accordingly, the user can recognize an appropriate setting value for the item of which a predetermined value is set and/or the item of which a value is not set in the setting information, and can appropriately update the setting information being set. Thus, the information processing apparatus 200 can enhance the convenience of the user.

The notification unit 225 may determine the recommended value within the range of the capability indicated in the capability information acquired in step S109 based on the characteristic information identified in the identification process. For example, the notification unit 225 extracts an item of which the setting value in the existing file setting information is not indicated as the executable setting value in the capability information among the plurality of items. The notification unit 225 determines, as the recommended value, a setting value with the highest capability among the setting values indicated in the capability information for the extracted item. For example, when the item is the resolution, a higher capability is required as the resolution is higher. When the item is the medium size, a higher capability is required as the size is larger. When the item is the color, a higher capability is required in the order of color, grayscale, and binary. Accordingly, the user can correct the setting information within the range executable by the image reading apparatus 100. Thus, the information processing apparatus 200 can enhance the convenience of the user.

The acquisition unit 221 acquires capability information of other image reading apparatuses different from the image reading apparatus 100 to be set or other software different from software installed in the image reading apparatus 100 to be set (step S111). The software is, for example, driver software that causes the image reading apparatus 100 to execute each process. Capability information of each image reading apparatus or each software included in the image processing system 1 is stored in advance, for example, in the second storage device 210 of the information processing apparatus 200 or a storage device of the server apparatus S. The acquisition unit 221 reads the capability information of each image reading apparatus or each software from the second storage device 210 or receives the capability information of each image reading apparatus or each software from the server apparatus S via the second communication device 201 and acquires the capability information of each image reading apparatus or each software.

The notification unit 225 identifies information relating to an image reading apparatus or software having a capability corresponding to the characteristic information identified by the identification process among the other image reading apparatuses or the other software and notifies the user of the information (step S112). The notification unit 225 notifies the user of the information relating to the image reading apparatus or the software having the capability corresponding to the characteristic information in a manner similar to the process in step S107. The information relating to the image reading apparatus or the software having the capability corresponding to the characteristic information is an example of information relating to a determination result, and is, for example, information indicating each image reading apparatus or each software.

The notification unit 225 extracts an image reading apparatus or software with the setting values of all items in the existing file setting information being indicated as executable setting values in the capability information, among the other image reading apparatuses or the other software with the capability information acquired in step S111. The notification unit 225 notifies the user of the information indicating each extracted image reading apparatus or software. Accordingly, the user can recognize the image reading apparatus or the software that can generate a file corresponding to the storage destination being set, and can acquire a desirable file using the image reading apparatus or the software. Thus, the information processing apparatus 200 can enhance the convenience of the user.

The identification unit 222 extracts a second storage destination different from the storage destination set by the user (step S113). For example, the identification unit 222 extracts all other storage destinations located in the vicinity of the storage destination being set as the second storage destination. The identification unit 222 extracts, as the second storage destination, a storage destination in which an existing file is present among all storage destinations that are reached by changing the hierarchy a predetermined number of times or less from the hierarchy of the storage destination being set. The identification unit 222 may extract a storage destination located in the same hierarchy as the hierarchy of the storage destination being set as the second storage destination.

The identification unit 222 executes an identification process on each extracted second storage destination (step S114). In the identification process, the identification unit 222 identifies characteristic information relating to each second storage destination, that is, characteristic information of an existing file present in each second storage destination, based on the existing file present in each second storage destination.

The determination unit 224 determines whether the setting information being set corresponds to the characteristic information relating to each second storage destination identified in the identification process (step S115). The determination unit 224 calculates a matching degree between the setting information and the characteristic information relating to each second storage destination in a manner similar to the process in step S106. When a matching degree between the setting information and characteristic information relating to a second storage destination is higher than the matching degree calculated in step S106 between the setting information and the characteristic information relating to the storage destination set by the user, the determination unit 224 determines that the setting information corresponds to the characteristic information relating to the second storage destination. When a matching degree between the setting information and characteristic information relating to a second storage destination is higher than a predetermined threshold value, the determination unit 224 may determine that the setting information corresponds to the characteristic information relating to the second storage destination.

When the setting information corresponds to the characteristic information relating to any one of second storage destinations, the notification unit 225 notifies the user of information relating to the second storage destination with the characteristic information corresponding to the setting information in a manner similar to the process in step S107 (step S116), and ends the series of steps. For example, the notification unit 225 notifies the user of information indicating all of the second storage destinations of which the characteristic information correspond to the setting information among the second storage destinations. The notification unit 225 may notify the user of information indicating a second storage destination having the highest matching degree with the setting information among the second storage destinations of which the characteristic information correspond to the setting information. Accordingly, the user can recognize a more suitable storage destination based on the setting information being set, and can appropriately correct the storage destination. Thus, the information processing apparatus 200 can enhance the convenience of the user.

When a plurality of second storage destinations having the highest matching degree with the setting information are present, that is, when a plurality of second storage destinations having the maximum matching degree with the setting information and having the same matching degree are present, the notification unit 225 may notify the user of information indicating a second storage destination having the latest access date and time or the latest update date and time. In general, image files of the same type may be classified and stored in different storage destinations (folders) on a date and time basis. In such a case, since the notification of the second storage destination having the latest access date and time or the latest update date and time is made, the user can recognize a storage destination more suitable for the setting information being set and can appropriately correct the storage destination. Thus, the information processing apparatus 200 can enhance the convenience of the user.

By contrast, when the setting information does not correspond to the characteristic information relating to any second storage destination, the notification unit 225 suggests creating a new storage destination in a manner similar to the process in step S107 (step S117), and ends the series of steps. That is, the notification unit 225 suggests creating a new storage destination for the user when the setting information does not correspond to the characteristic information relating to the storage destination and the characteristic information relating to any of all the second storage destinations. Accordingly, when the storage destination corresponding to the setting information set by the user is not present yet, the file generated in accordance with the setting information can be stored in the new storage destination. Thus, the information processing apparatus 200 can appropriately classify and manage each file.

When the process in step S103 is omitted and when an existing file is not present in the storage destination set by the user, the setting unit 223 may proceed to step S104 and set the setting information and storage destination being set in the corresponding image reading apparatus 100. The process in step S107 may be omitted. The process in step S108 or S109 may be omitted. The processes in steps S108, S109, and S110 may be omitted. The processes in step S111 and S112 may be omitted. The processes in step S116 and/or step S117 may be omitted. When the processes in both steps S116 and S117 are omitted, the processes in steps S113 to S115 may be omitted.

Even when it is determined in step S106 that the setting information corresponds to the characteristic information, the processes in steps S113 to S116 may be executed. In this case, even when the setting information corresponds to the characteristic information relating to the storage destination set by the user, the notification unit 225 notifies the user of information relating to the second storage destination having a higher matching degree with the setting information than the matching degree with the setting information of the storage destination set by the user. Accordingly, the user can recognize the presence of the storage destination having the higher matching degree with respect to the setting information being set, and can reconsider whether the storage destination being set is appropriate.

The processes in steps S113 to S116 may be executed even when a folder of the storage destination set by the user is not present. In this case, in step S115, the determination unit 224 determines that the setting information corresponds to the characteristic information relating to the second storage destination when the matching degree between the setting information and the characteristic information relating to the second storage destination is higher than a predetermined threshold value. Accordingly, the user can recognize the storage destination having the highest matching degree with respect to the setting information being set.

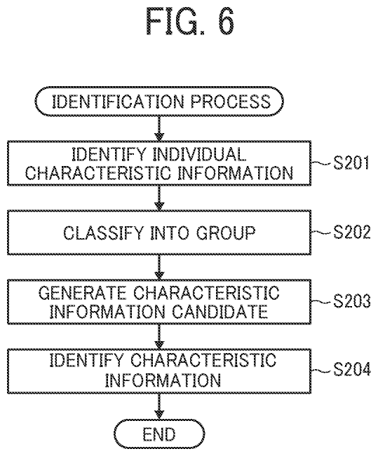

FIG. 6 is a flowchart presenting an example of an operation of an identification process. The identification process presented in FIG. 6 is executed in steps S105 and S114 in FIG. 5.

The identification unit 222 identifies individual characteristic information of each of one or more existing files present in a target storage destination (step S201).

The identification unit 222 identifies, as the individual characteristic information, a setting value of each item when each existing file is generated, for each of one or more items determined in the setting information.

The identification unit 222 refers to meta information included in an existing file and identifies setting values of the resolution, medium size, file format, presence of compression, quantization value, and color of an image included in the existing file. The identification unit 222 may identify the resolution or medium size from the medium size or resolution included in the meta information and the number of pixels of the image included in the existing file. The identification unit 222 may estimate the resolution based on the spatial frequency of the image included in the existing file. In this case, an expression or a table indicating the relationship between the maximum value of the spatial frequency and the resolution is set in the second storage device 210 in advance. The identification unit 222 identifies the resolution corresponding to the spatial frequency with reference to the expression or the table set in advance. The identification unit 222 may compare the maximum difference in gradation value among pixels in each pixel block of the image included in the existing file with a threshold value to estimate the presence of compression and/or the quantization value. The identification unit 222 may identify the setting value of the color (binary, grayscale, color) based on the distribution (range) of color values and/or brightness values of the image included in the existing file.

The identification unit 222 determines whether the setting value of the reading side is simplex or duplex based on whether serial numbers such as page numbers are included in two images included in two existing files having names or creation dates and times being next to each other, or based on whether the similarity degree between images is a threshold value or more. The similarity degree is, for example, a normalized cross-correlation value.

The identification unit 222 determines that the setting value of the multi-image output is ON when the similarity degree between brightness values of pixels in images included in each of a plurality of existing files is a first threshold value or more and the similarity degree between color values of the pixels in the images is a second threshold value or less.

The identification unit 222 determines that the setting value of the spread combination is ON when the number of files including images of a predetermined size (for example, A3 size) is ½ of the number of files including images of a size that is half the predetermined size (for example, A4 size).

The identification unit 222 determines whether the setting value of the OCR is ON or OFF based on whether a character recognized by the OCR is included in meta information included in an existing file, and identifies the language of the OCR based on the character included in the meta information. The identification unit 222 may determine that the setting value of the OCR is ON when a predetermined reference mark used for OCR recognition is included in an image included in an existing file. The identification unit 222 may determine that the setting value of the OCR is ON when a handwritten character is included in an image included in an existing file. In this case, the identification unit 222 determines whether a handwritten character is included in an image using a discriminator trained in advance to output whether a handwritten character is included in the image. The discriminator is trained in advance by, for example, deep learning using a plurality of images including various handwritten characters, and is stored in the second storage device 210 in advance. The identification unit 222 inputs an image included in an existing file to the discriminator, and determines whether the image included in the existing file includes a handwritten character based on information output from the discriminator.

The identification unit 222 determines that the setting value of the barcode recognition is ON when a barcode is included in an image included in an existing file.

The identification unit 222 determines whether the setting value of the e-document reading setting is ON or OFF based on whether an image included in an existing file is an image on which specific hue adjustment and/or specific tone adjustment that are used when the e-document reading mode is set have been performed. The identification unit 222 calculates a similarity degree between a distribution pattern of hues and/or a distribution pattern of gradation values of an image included in an existing file, and a distribution pattern determined in advance as a distribution pattern specific to an image read by the e-document reading mode. The similarity degree is, for example, a normalized cross-correlation value. The identification unit 222 determines whether the setting value of the e-document reading setting is ON or OFF based on whether the similarity degree is a threshold value or more.

The identification unit 222 detects an end position of a medium from an image included in an existing file using a known image processing technique, and determines whether the setting value of the size detection is fixed size or automatic size detection based on whether a margin (blank area) is present in an area outside the end position.

The identification unit 222 determines whether the setting value of the sharpness correction is ON or OFF based on whether the maximum value of the differences between gradation values of pixels adjacent to each other in an image included in an existing file is a threshold value or more.

The identification unit 222 detects a medium area in an image included in an existing file using a known image processing technique, and determines that the orientation correction has not been performed and the setting value of the orientation correction is OFF when the inclination of the detected medium area is a threshold value or more. The identification unit 222 may determine whether the orientation correction has been performed and determine whether the setting value of the orientation correction is ON or OFF with reference to orientation information included in Exchangeable image file format (Exif) information of an existing file.

When the identification unit 222 detects a stamp in an image included in an existing file, the identification unit 222 determines that the stamp has not been removed and the setting value of the dropout color is OFF. For example, when a pixel group, in which pixels having a red color and being adjacent to each other are connected, has a predetermined size that is regarded as a stamp, the identification unit 222 determines that the pixel group includes a stamp.

When the identification unit 222 detects a ground pattern in an image included in an existing file, the identification unit 222 determines that the background pattern has not been removed and the setting value of the background pattern removal is OFF. For example, when the identification unit 222 detects thin lines or dots having gradation values in a predetermined range and the detected thin lines or dots are continuously present in the image at a predetermined interval, the identification unit 222 determines that the image includes a ground pattern.

When an image included in an existing file has an image characteristic that causes moire, the identification unit 222 determines that the user likely wants to reduce moire and the setting value of the moire reduction is ON. For example, when print spots (dots) are continuously preset at a predetermined interval, the identification unit 222 determines that the image has an image characteristic that causes moire. When an image included in an existing file includes a newspaper article, the identification unit 222 may determine that the image has an image characteristic that causes moire. For example, the identification unit 222 determines whether an image has an image characteristic that causes moire using a discriminator trained in advance to output information indicating whether the image has the image characteristic that causes moire. The discriminator is trained in advance by, for example, deep learning using a plurality of images having image characteristics that cause moire, and is stored in the second storage device 210 in advance. The identification unit 222 inputs an image included in an existing file to the discriminator, and determines whether the image has an image characteristic that causes moire based on information output from the discriminator.

When the variation degree of gradation values of pixels in an image included in an existing file is a threshold value or more, the identification unit 222 determines that the tone curve adjustment has been executed on the image and the setting value of the tone curve adjustment is ON. The variation degree is, for example, a distribution or a standard deviation.

The identification unit 222 detects a rectangular area including a medium in an image included in an existing file using a known image processing technique, and determines that a tab has not been removed and the setting value of the tab cropping is OFF when an object of a predetermined size is present which is outside but adjacent to the detected rectangular area.

When an image included in an existing file includes a predetermined symbol and does not include ruled lines, the identification unit 222 determines that ruled lines have been removed and the setting value of the ruled line removal is ON. The predetermined symbol is, for example, a symbol such as a circle mark, a cross mark, or a check mark that is likely to be included in a medium including ruled lines, such as a questionnaire sheet or an examination sheet. The identification unit 222 determines whether the image includes a predetermined symbol using an OCR technique.

The identification unit 222 executes a color clustering process on an image included in an existing file, and determines whether the setting value of the color reduction process is ON or OFF based on the number of groups of classified colors. When the number of groups of classified colors is a first threshold value or less, the identification unit 222 determines that the color reduction process has been executed on the image and the setting value of the color reduction process is ON. By contrast, when the number of groups of classified colors is a second threshold value or more that is the first threshold value or more, the identification unit 222 determines that the color reduction process has not been executed on the image and the setting value of the color reduction process is OFF.

When the file format of an existing file is PDF and a plurality of images are included in one existing file, the identification unit 222 determines that a plurality of media have been collectively conveyed, and determines that the setting value of the medium separation is ON. When an image included in an existing file includes a machine readable zone (MRZ), the identification unit 222 determines that a passport has been conveyed, and determines that the setting value of the medium separation is OFF. The identification unit 222 determines whether the image includes a MRZ using an OCR technique.

When the file format of an existing file is PDF and a plurality of images are included in one existing file, the identification unit 222 determines that a plurality of media have been collectively conveyed, and determines that the setting value of the multi-feed detection is ON. When an image included in an existing file includes a zip code entry frame or a sticky note, the identification unit 222 determines that an envelope or a sheet with a sticky note attached has been conveyed, and determines that the setting value of the multi-feed detection is OFF. The identification unit 222 detects a rectangular area from the image using a known image processing technique, and determines that the image includes an envelope or a sticky note when the size of the detected rectangular area has a size that can be regarded as a zip code entry frame or a sticky note. The identification unit 222 determines that the image includes an envelope when detecting characters specific to an envelope, such as “postage deferred payment” or “closed (seal)”, from the image using an OCR technique.

The identification unit 222 may identify the medium type corresponding to each existing file as individual characteristic information.

For example, the identification unit 222 identifies the medium type corresponding to each existing file based on the setting value of each item when the existing file is generated, which is identified as described above. The identification unit 222 identifies a medium type having the largest number of items with the setting values determined in the type table match the identified setting values among the medium types determined in the type table, as the medium type corresponding to each existing file.

The identification unit 222 may analyze an image included in an existing file and identify the medium type corresponding to the existing file. The information processing apparatus 200 stores, for each of a plurality of medium types, a hue component and/or an arrangement position of an object, such as ruled lines, a character, or a figure, corresponding to the medium type in the second storage device 210 in advance. The identification unit 222 detects a hue component based on the distribution of color values of pixels and/or detects an object using a pattern matching technique from an image included in an existing file. The identification unit 222 identifies, as the medium type corresponding to the existing file, the medium type with the hue component and/or the arrangement position of each object being the most approximate to the detected hue component and/or the detected arrangement position of each object among the medium types stored in advance.

The identification unit 222 may identify the medium type corresponding to an existing file using a discriminator trained in advance to output, when an image is input, information indicating the medium type included in the image. The discriminator is trained in advance by, for example, deep learning using a plurality of images including various types of media, and is stored in the second storage device 210 in advance. The identification unit 222 inputs an image included in an existing file to the discriminator, and identifies the type indicated in information output from the discriminator as the medium type corresponding to the existing file.

The identification unit 222 may store individual characteristic information identified from an image included in an existing file in meta information of the existing file. Alternatively, the identification unit 222 may generate a list in which individual characteristic information identified from an image included in an existing file is stored. Accordingly, thereafter, when another information processing apparatus 200 or the image reading apparatus 100 has to identify the individual characteristic information of the existing file, the other information processing apparatus 200 or the image reading apparatus 100 can identify the individual characteristic information more easily in a short period of time.

The identification unit 222 classifies pieces of individual characteristic information of existing files into one or more groups (step S202). The identification unit 222 groups pieces of individual characteristic information approximate to each other among the pieces of individual characteristic information of the existing files together. For example, the identification unit 222 regards pieces of individual characteristic information of which the setting values of a predetermined number or more of items match each other among the pieces of individual characteristic information, as pieces of individual characteristic information approximate to each other, and groups the pieces of individual characteristic information together. The identification unit 222 may regard pieces of individual characteristic information of which the setting values of a predetermined item (for example, medium size) match each other among the pieces of individual characteristic information, as pieces of individual characteristic information approximate to each other, and may group the pieces of individual characteristic information together. The identification unit 222 may identify medium types corresponding to existing files, regard pieces of individual characteristic information of existing files with the same medium type as pieces of individual characteristic information approximate to each other, and group the pieces of individual characteristic information together.

The identification unit 222 generates a characteristic information candidate for each classified group based on statistics of individual characteristic information belonging to each group (step S203).

When individual characteristic information is a setting value of each item when each existing file is generated, the identification unit 222 extracts a setting value having the maximum frequency, that is, the mode of setting values for each of the plurality of items of the individual characteristic information belonging to each group. The identification unit 222 generates a combination of the modes extracted for the items as a characteristic information candidate. The identification unit 222 may generate a characteristic information candidate focusing on one or more predetermined items instead of all of the items. When each group is classified in accordance with the medium type, an item to be focused may be set in advance for each medium type. The identification unit 222 may extract individual characteristic information of an existing file having the largest number of items of which the values in the individual characteristic information are the same as the modes, as a characteristic information candidate.

When the individual characteristic information is the medium type corresponding to each existing file, the identification unit 222 identifies a medium type that is the most frequently identified as the individual characteristic information, as a characteristic information candidate.

In this way, the identification unit 222 generates a plurality of characteristic information candidates based on each statistics of groups of individual characteristic information pieces that are approximate to each other among individual characteristic information pieces of a plurality of existing files. Accordingly, even when various types of existing files are stored in the target storage destination, the identification unit 222 can identify characteristic information corresponding to each existing file with high accuracy without mixing different characteristics of the existing files.

The identification unit 222 identifies a characteristic information candidate the most approximate to the setting information among the plurality of generated characteristic information candidates as mainstream characteristic information of the existing files present in the target storage destination (step S204), and ends the series of steps.

When the individual characteristic information (characteristic information candidate) is the setting value of each item when each existing file is generated, the identification unit 222 determines whether the setting value in each characteristic information candidate matches the setting value in the setting information for each of the plurality of items. The identification unit 222 identifies a characteristic information candidate having the largest number of items with the matching setting values among the plurality of characteristic information candidates, as a characteristic information candidate the most approximate to the setting information.

When the individual characteristic information (characteristic information candidate) is the medium type corresponding to each existing file, the identification unit 222 refers to the type table and identifies a setting value determined in the type table for each of the plurality of items, for the medium type relating to each characteristic information candidate. The identification unit 222 determines whether the setting value relating to each characteristic information candidate matches the setting value in the setting information for each of the plurality of items. The identification unit 222 identifies a characteristic information candidate (medium type) having the largest number of items with the matching setting values among the plurality of characteristic information candidates, as a characteristic information candidate the most approximate to the setting information.

The identification unit 222 may identify characteristic information focusing on one or more predetermined items instead of focusing on all of the items. When each group is classified in accordance with the medium type, an item to be focused may be set in advance for each medium type. When there is one existing file stored in the target storage destination, the identification unit 222 identifies individual characteristic information of the existing file as the characteristic information.

As described above, the identification unit 222 identifies the existing file setting information relating to the conveyance processing, the image-capturing processing, or the image processing used when the existing file is generated, as the individual characteristic information, and identifies the existing file setting information as the characteristic information. Accordingly, the information processing apparatus 200 can determine whether the setting by the user is appropriate using the characteristic information indicating the characteristics of the existing file in more detail.

The identification unit 222 identifies the medium type corresponding to the existing file as the individual characteristic information and identifies the medium type as the characteristic information. Accordingly, the information processing apparatus 200 can determine whether the setting of the user is appropriate using the characteristic information appropriately indicating the entire characteristics of the existing file.

When the identification process is performed in step S105 in FIG. 5, the storage destination set by the user or another storage destination corresponding to the storage destination set by the user serves as the target storage destination. That is, when an existing file is not present in the storage destination set by the user, the identification unit 222 identifies characteristic information based on an existing file present in another storage destination corresponding to the storage destination set by the user. Accordingly, the identification unit 222 can appropriately determine whether the setting information or the storage destination set by the user is appropriate even when the storage destination set by the user is not present yet, such as when a file is stored in different storage destinations depending on the creation date and time.

By contrast, when the identification process is performed in step S114 in FIG. 5, the second storage destination different from the storage destination set by the user, in particular, all other storage destinations located in the vicinity of the storage destination set by the user are considered the target storage destinations. That is, the identification unit 222 identifies characteristic information relating to the second storage destination, in particular, characteristic information relating to each of all the other storage destinations located in the vicinity of the storage destination set by the user.

The processes in steps S202 and S203 may be omitted, and the identification unit 222 may identify mainstream characteristic information without grouping pieces of individual characteristic information. In this case, the identification unit 222 identifies the mainstream characteristic information based on the statistics of the individual characteristic information of each of the plurality of existing files identified in step S201, in a manner similar to the case of generating the characteristic information candidate in step S203. When the individual characteristic information is the setting value of each item used when each existing file is generated, the identification unit 222 extracts the mode of setting values for each of the plurality of items for the individual characteristic information of each existing file, and generates a combination of the modes of the items as mainstream characteristic information. The identification unit 222 may extract individual characteristic information of an existing file having the largest number of items of which the values in the individual characteristic information are the same as the modes, as mainstream characteristic information. When the individual characteristic information is the medium type corresponding to each existing file, the identification unit 222 identifies a medium type identified most frequently among the medium types identified as the individual characteristic information, as mainstream characteristic information. Even in these cases, the identification unit 222 can accurately identify characteristic information indicating the characteristics of each existing file.

In step S106 in FIG. 5, the determination unit 224 may determine whether the setting information being set corresponds to each of the characteristic information candidates generated in step S203 in addition to determining whether the setting information being set corresponds to the characteristic information. In this case, when a characteristic information candidate not corresponding to the setting information set by the user is present, the notification unit 225 notifies the user of a warning indicating the presence of the characteristic information candidate not corresponding to the setting information set by the user.

As described above in detail, the information processing apparatus 200 notifies the user when the setting information set by the user does not match the characteristic information identified from the existing file present in the storage destination set by the user. Accordingly, the information processing apparatus 200 can avoid a setting error of the setting information or the storage destination by the user, and can enhance the convenience of the user.

In particular, even when the user has low knowledge or low skill relating to the image reading process, the information processing apparatus 200 notifies the user of a setting error, thereby preventing an image file from being generated in accordance with erroneous setting information. Even when the user does not have a medium to be read, the information processing apparatus 200 notifies the user of a setting error, thereby preventing an image file from being generated in accordance with erroneous setting information. Accordingly, the information processing apparatus 200 can prevent a redo of the image reading process of the image reading apparatus 100, and can prevent a decrease in work efficiency or work quality of the user.

When the image reading apparatus 100 is used for operations or private purpose, a role or a purpose is likely to be explicitly or implicitly assigned to a folder of a storage destination in which an image file that is generated by the image reading apparatus 100 is stored. For example, documents relating to household economies such as receipts or lists of charges, business cards, or order forms are likely to be stored in the same storage destination so that the documents, the business cards, or the order forms are collectively managed. The information processing apparatus 200 allows a folder of a storage destination to store an image file corresponding to the role or purpose assigned to the folder, and can appropriately manage an image to be generated by the image reading apparatus 100.

Even when a plurality of users set the setting information of the image reading apparatus 100, the information processing apparatus 200 can enhance uniformity of image files stored in a folder of each storage destination. By improving the uniformity of image files stored in a folder of each storage destination, the information processing apparatus 200 can enhance searchability of the image files. Since the image files stored in the folder of the storage destination are generated in accordance with the same setting information, the information processing apparatus 200 can perform common processes in post processing on the image files, thereby increasing efficiency of the post processing. Since the information processing apparatus 200 can reliably store image files generated in accordance with predetermined setting information in an appropriate storage destination, the information processing apparatus 200 can enhance viewability, prevent falsification, and properly manage the image files in conformity with, for example, the e-document law.

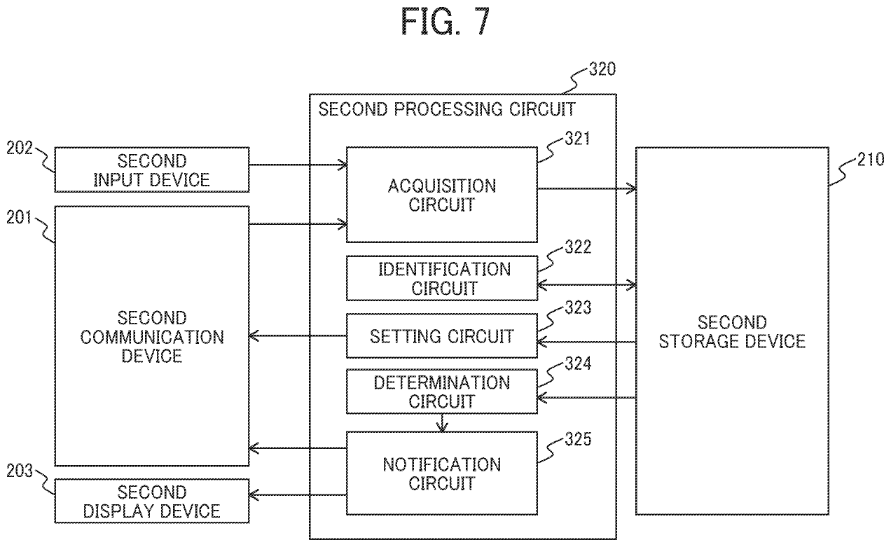

FIG. 7 is a block diagram schematically illustrating a configuration of a second processing circuit 320 in an information processing apparatus according to another embodiment.

The second processing circuit 320 is used instead of the second processing circuit 220 and executes, for example, a determination process. The second processing circuit 320 includes an acquisition circuit 321, an identification circuit 322, a setting circuit 323, a determination circuit 324, and a notification circuit 325.

The acquisition circuit 321 is an example of an acquisition unit and functions like the acquisition unit 221. The acquisition circuit 321 receives setting information and a storage destination from the second communication device 201 or the second input device 202, and stores the setting information and the storage destination in the second storage device 210.

The identification circuit 322 is an example of an identification unit and functions like the identification unit 222. The identification circuit 322 reads the storage destination from the second storage device 210, extracts characteristic information of an existing file present in the storage destination, and stores the characteristic information in the second storage device 210.

The setting circuit 323 is an example of a setting unit and functions like the setting unit 223. The setting circuit 323 reads the setting information and the storage destination from the second storage device 210, and transmits a setting request signal that designates the setting information and the storage destination to the corresponding image reading apparatus 100 via the second communication device 201.

The determination circuit 324 is an example of a determination unit and functions like the determination unit 224. The determination circuit 324 reads the setting information and the characteristic information from the second storage device 210, determines whether the setting information corresponds to the characteristic information, and outputs a determination result to the notification circuit 325.

The notification circuit 325 is an example of a notification unit and functions like the notification unit 225. The notification circuit 325 receives the determination result of whether the setting information corresponds to the characteristic information from the determination circuit 324, and outputs information relating to the determination result to the second communication device 201 or the second display device 203.

As described above in detail, the information processing apparatus can enhance the convenience of the user even when the second processing circuit 320 is used.

Although the preferred embodiments have been described above, the embodiments are not limited thereto. For example, the determination process may be executed by the image reading apparatus 100 instead of the information processing apparatus 200. In this case, the first storage device 110 of the image reading apparatus 100 stores each information and each program stored in the second storage device 210 of the information processing apparatus 200. The first processing circuit 120 functions as an acquisition unit, an identification unit, a setting unit, a determination unit, and a notification unit similar to the acquisition unit 221, the identification unit 222, the setting unit 223, the determination unit 224, and the notification unit 225.

In this case, in step S101 of FIG. 5, the acquisition unit acquires setting information and a storage destination input by the user using the first input device 102. Alternatively, the acquisition unit receives setting information and a storage destination input by the user using the second input device 202 of the information processing apparatus 200 from the information processing apparatus 200 via the first communication device 101 to acquire the setting information and the storage destination. In steps S105, S110, S112, S116, and S117, the notification unit notifies the user of each information by displaying each information of the first display device 103 or by transmitting each information to the information processing apparatus 200 via the first communication device 101 and causing the information processing apparatus 200 to display the information. The setting controller 121 functions as the setting unit.

Accordingly, the image reading apparatus 100 can enhance the convenience of the user.

It is desired to enhance convenience of a user in a system using an image reading apparatus.

According to one embodiment of the present disclosure, an image processing apparatus, a control method, and a non-transitory computer-executable medium that can enhance the convenience of a user are provided.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An image processing apparatus, comprising circuitry configured to:
acquire setting information relating to conveyance processing, image-capturing processing, or image processing of an image reading apparatus and a storage destination of a file that is generated in accordance with the setting information, wherein the setting information and the storage destination are set by a user;
identify characteristic information of an existing file present in the storage destination;
determine whether the setting information corresponds to the characteristic information and generate a determination result; and
notify the user of information relating to the determination result in a case where the determination result indicates that the setting information does not correspond to the characteristic information.

2. The image processing apparatus according to claim 1, wherein the circuitry is configured to identify, as the characteristic information, existing file setting information relating to the conveyance processing, the image-capturing processing, or the image processing used when the existing file was generated.

3. The image processing apparatus according to claim 2, wherein the circuitry is configured to notify the user that the setting information is not appropriate as the determination result in a case where the determination result indicates that the setting information does not correspond to the existing file setting information.

4. The image processing apparatus according to claim 1, wherein the circuitry is configured to identify a medium type corresponding to the existing file as the characteristic information.

5. The image processing apparatus according to claim 4, wherein the circuitry is configured to notify the user that the storage destination is not appropriate as the determination result in a case where the determination result indicates that the setting information does not correspond to the medium type.

6. The image processing apparatus according to claim 1, wherein the circuitry is configured to:
identify individual characteristic information of each of a plurality of existing files present in the storage destination; and
identify the characteristic information based on statistics of the individual characteristic information of each of the plurality of existing files.

7. The image processing apparatus according to claim 6, wherein the circuitry is configured to:
generate a plurality of characteristic information candidates based on each statistic of groups of individual characteristic information that are approximate to each other among the individual characteristic information of the plurality of existing files; and
identify a characteristic information candidate that is the most approximate to the setting information among the plurality of characteristic information candidates as the characteristic information.

8. The image processing apparatus according to claim 1, wherein the circuitry is configured to further notify the user of a recommended value for an item of which a predetermined value is set or an item of which a value is not set in the setting information based on the characteristic information.

9. The image processing apparatus according to claim 1, wherein the circuitry is configured to:
further acquire capability information indicating a capability relating to the conveyance processing, the image-capturing processing, or the image processing of the image reading apparatus; and
notify the user of a recommended value for a setting relating to the image-capturing processing or the image processing within a range of the capability indicated in the capability information based on the characteristic information.

10. The image processing apparatus according to claim 1, wherein the circuitry is configured to identify the characteristic information based on an existing file present in another storage destination corresponding to the storage destination in a case where the existing file is not present in the storage destination.

11. The image processing apparatus according to claim 1, wherein the circuitry is configured to:
further identify the characteristic information relating to a second storage destination different from the storage destination; and
notify the user of information relating to the second storage destination when a matching degree between the setting information and the characteristic information relating to the second storage destination is higher than a matching degree between the setting information and the characteristic information relating to the storage destination.

12. The image processing apparatus according to claim 1, wherein the circuitry is configured to:
further identify the characteristic information relating to each of all other storage destinations located in a vicinity of the storage destination; and
suggest creating a new storage destination in a case where the setting information does not correspond to any of the characteristic information relating to the storage destination and the characteristic information relating to all the other storage destinations.

13. The image processing apparatus according to claim 1, wherein
the image reading apparatus includes software installed therein; and
the circuitry is configured to:
set the setting information in a second image reading apparatus to the image reading apparatus, wherein the second image reading apparatus is different from the image reading apparatus, and the setting information in the second image reading apparatus is set by the user; and
in a case that the setting information set in the second image reading apparatus does not correspond to the characteristic information, further acquire capability information indicating a capability relating to the image-capturing processing or the image processing of other image reading apparatuses or other software different from the software, and notify the user of information relating to an image reading apparatus or software having the capability corresponding to the characteristic information among the other image reading apparatuses or the other software.

14. A control method, comprising:
acquiring setting information relating to conveyance processing, image-capturing processing, or image processing of an image reading apparatus and a storage destination of a file that is generated in accordance with the setting information, wherein the setting information and the storage destination are set by a user;
identifying characteristic information of an existing file present in the storage destination;
determining whether the setting information corresponds to the characteristic information and generating a determination result; and
notifying the user of information relating to the determination result in a case where the determination result indicates that the setting information does not correspond to the characteristic information.

15. A non-transitory computer-executable medium storing a control program storing a plurality of instructions, which, when executed by one or more processors, causes the one or more processors to perform a method comprising:
acquiring setting information relating to conveyance processing, image-capturing processing, or image processing of an image reading apparatus and a storage destination of a file that is generated in accordance with the setting information, wherein the setting information and the storage destination are set by a user;
identifying characteristic information of an existing file present in the storage destination;
determining whether the setting information corresponds to the characteristic information and generating a determination result; and
notifying the user of information relating to the determination result in a case where the determination result indicates that the setting information does not correspond to the characteristic information.
